(19) United States
(12) Patent Application Publication
(10) Pub. No.: US 2025/0364204 A1
(43) Pub. Date: Nov. 27, 2025

(54) FIELD EMISSION DEVICE, AND X-RAY GENERATION DEVICE USING SAME

(71) Applicant: LG ELECTRONICS INC., Seoul (KR)

(72) Inventors: Jinah KIM, Seoul (KR); Byungkee LEE, Seoul (KR); Giwon LEE, Seoul (KR); Hyojin NAM, Seoul (KR); Jeongsoon YIM, Seoul (KR); Eunju HONG, Seoul (KR); Hyungjo PARK, Seoul (KR)

(73) Assignee: LG ELECTRONICS INC., Seoul (KR)

(21) Appl. No.: 18/874,727

(22) PCT Filed: Jun. 17, 2022
(86) PCT No.: PCT/KR2022/008626

§ 371 Date: Dec. 13, 2024

(51) Int. Cl. H01J 35/06; H01J 1/304; H01J 1/308

(52) U.S. Cl. CPC H01J 35/065; H01J 1/304; H01J 1/308; H01J 2201/308; H01J 2235/062; H01J 2235/18

(57) ABSTRACT

The present disclosure relates to a field emission device that generates X-rays by emitting an electron beam, and an X-ray generating apparatus using the same, including a semiconductor substrate; a bottom electrode disposed below the semiconductor substrate; an insulating layer disposed above the semiconductor substrate; a gate electrode disposed on the insulating layer; and, a top electrode disposed on the gate electrode; wherein the gate electrode is composed of a material satisfying at least one of a first condition for work function, a second condition for Gibbs free energy of a redox reaction with the insulating layer, a third condition for sublimation energy, and a fourth condition for electron mean free path.

### TECHNICAL FIELD

The present disclosure relates to a field emission device that generates X-rays by emitting an electron beam and an X-ray generating apparatus using the same.

### BACKGROUND ART

In general, an X-ray generating apparatus is widely used for medical diagnosis and non-destructive testing to reveal defects inside various structures.

The X-ray generating apparatus can use field emission devices of various structures as X-ray emission sources.

Recently, X-ray generating apparatus have been using field emission devices with a Metal Insulator Semiconductor (MIS) structure as X-ray emission sources in order to achieve miniaturization and improved resolution.

The field emission device of the MIS structure includes a semiconductor layer, an insulating layer, and a gate electrode layer, and the field emission performance, reliability, and stability can be determined according to the conditions of the constituent materials, thickness, and structure thereof.

Therefore, in the future, the development of a field emission device capable of improving field emission performance, reliability, and stability is required, and the development of an X-ray emission device with excellent X-ray generation efficiency and reliability by applying the corresponding field emission device is required.

### DISCLOSURE

### Technical Problem

An object of the present disclosure is to solve the problems described above and the other problems.

An object of the present disclosure is to provide a field emission device which can improve field emission performance, reliability and stability by forming a semiconductor layer, an insulating layer and a gate electrode layer based on specific conditions, and an X-ray generating apparatus using the same.

### Technical Solution

A field emission device according to one embodiment of the present disclosure includes a semiconductor substrate; a bottom electrode disposed below the semiconductor substrate; an insulating layer disposed above the semiconductor substrate; a gate electrode disposed on the insulating layer; and, a top electrode disposed on the gate electrode; in which the gate electrode may be composed of a material satisfying at least one of a first condition for work function, a second condition for Gibbs free energy of a redox reaction with the insulating layer, a third condition for sublimation energy, and a fourth condition for electron mean free path.

An X-ray generating apparatus according to one embodiment of the present disclosure includes a field emission device having a plurality of electron beam emitting regions arranged; and an anode generating X-rays by collision with electrons emitted from the electron beam emission region of the field emission device and reflects and transmits the X-rays in a specific direction, in which the field emission device may include a semiconductor substrate; a bottom electrode disposed below the semiconductor substrate; an insulating layer disposed above the semiconductor substrate; a gate electrode disposed on the insulating layer; and, a top electrode disposed on the gate electrode; in which the gate electrode may be composed of a material satisfying at least one of a first condition for work function, a second condition for Gibbs free energy of a redox reaction with the insulating layer, a third condition for sublimation energy, and a fourth condition for electron mean free path.

### Advantageous Effect

According to one embodiment of the present disclosure, a field emission device and an X-ray generating apparatus using the same can improve field emission performance, reliability, and stability by forming a semiconductor layer, an insulating layer, and a gate electrode layer based on specific conditions.

### DESCRIPTION OF DRAWINGS

FIG. 1 is a cross-sectional view illustrating a field emission device according to one embodiment of the present disclosure.

FIG. 2 is a view illustrating an energy band diagram of a field emission device according to an embodiment of the present disclosure.

FIGS. 3 and 4 are graphs illustrating the performance of a field emission device according to the conditions of the gate electrode.

FIGS. 5a and 5b are graphs illustrating the performance of a field emission device according to the material of the gate electrode.

FIG. 6 is a cross-sectional view illustrating a field emission device according to another embodiment of the present disclosure.

FIG. 7 is a graph illustrating electrical characteristics of a field emission device according to another embodiment of the present disclosure.

FIG. 8 is a cross-sectional view illustrating the boundary between semiconductor layers with different doping concentrations.

FIGS. 9a to 9c are graphs illustrating the doping profile of the AB cross section of FIG. 8.

FIGS. 10 to 12 are cross-sectional views illustrating a field emission device according to another embodiment of the present disclosure.

FIG. 13 is a graph illustrating the doping profile for the field emission devices of FIGS. 11 and 12.

FIG. 14 is a cross-sectional view illustrating electrical connections of a field emission device according to one embodiment of the present disclosure.

FIGS. 15 to 17 are cross-sectional views illustrating an X-ray generating apparatus according to an embodiment of the present disclosure.

FIGS. 18a and 18b are views illustrating an X-ray tube to which the field emission device of the present disclosure is applied.

### BEST MODE

Hereinafter, embodiments disclosed in this specification will be described in detail with reference to the attached drawings, wherein. regardless of the drawing symbols, identical or similar components will be given the same reference numerals and redundant descriptions thereof will be omitted. The suffixes “module” and “part” used for components in the following description are assigned or used interchangeably only for the convenience of writing the specification, and do not have distinct meanings or roles in themselves. In addition, when describing embodiments disclosed in this specification, if it is determined that a specific description of a related known technology may obscure the gist of the embodiments disclosed in this specification, the detailed description thereof will be omitted. In addition, the attached drawings are only intended to facilitate easy understanding of the embodiments disclosed in this specification, and the technical ideas disclosed in this specification are not limited by the attached drawings, and should be understood to include all modifications, equivalents, and substitutes included in the idea and technical scope of the present disclosure.

Terms including ordinal numbers, such as first, second, and the like, may be used to describe various components, but the components are not limited by the terms. The terms are used only to distinguish one component from another.

When it is said that a component is “connected” or “accessed” to another component, it should be understood that it may be directly connected or accessed to that other component, but that there may be other components in between. On the other hand, when it is said that a component is “directly connected” or “directly accessed” to another component, it should be understood that there are no other components in between.

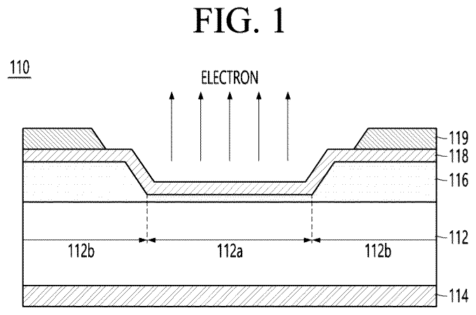

FIG. 1 is a cross-sectional view illustrating a field emission device according to one embodiment of the present disclosure.

As illustrated in FIG. 1, the field emission device 110 of the present disclosure illustrates, as an example, a field emission device having a MIS (Metal Insulator Semiconductor) structure, and the present disclosure is applicable to field emission devices of various structures, including a field emission device having a MIM (Metal-Insulator-Metal) structure.

The field emission device 110 of the present disclosure may include a semiconductor substrate 112, a bottom electrode 114 disposed below the semiconductor substrate 112, an insulating layer 116 disposed above the semiconductor substrate 112, a gate electrode 118 disposed on the insulating layer 116, and a top electrode 119 disposed on the gate electrode 118.

Here, the gate electrode 118 may be composed of a material that satisfies at least one of a first condition for the work function, a second condition for the Gibbs free energy of the redox reaction with the insulating layer 116, a third condition for the sublimation energy, and a fourth condition for the electron mean free path.

For example, the gate electrode 118 may be composed of a material that satisfies one of a first condition in which the work function is about 5.5 eV or less, a second condition in which the Gibbs free energy has a positive value, a third condition in which sublimation energy is about 300 kJ/mol or more, and a fourth condition in which the electron mean free path is about 0.9 nm or more.

As another example, the gate electrode 118 may be composed of a material that satisfies a plurality of conditions among a first condition in which the work function is about 5.5 eV or less, a second condition in which the Gibbs free energy has a positive value, a third condition in which sublimation energy is about 300 kJ/mol or more, and a fourth condition in which the electron mean free path is about 0.9 nm or more.

As another example, the gate electrode 118 may be composed of any one of graphene, metal, and metal compound materials that satisfy a plurality of conditions among a first condition in which the work function is about 5.5 eV or less, a second condition in which the Gibbs free energy has a positive value, a third condition in which sublimation energy is about 300 kJ/mol or more, and a fourth condition in which the electron mean free path is about 0.9 nm or more.

For example, the gate electrode 118 may be composed of any one of graphene, W, Mo, TiN, Au, Ir, and Pt, but this is only an example and is not limited thereto.

In some cases, the gate electrode 118 may be preferentially composed of a material that satisfies a condition with a higher priority among the first to fourth conditions based on preset priorities.

As an example, the preset priorities may be set such that the first condition for the work function is set as the first priority, the second condition for the Gibbs free energy as the second priority, the third condition for sublimation energy as the third priority, and the fourth condition for the electron mean free path as the fourth priority, but this is only an example and is not limited thereto.

In another case, the gate electrode 118 may be preferentially composed of a material that satisfies the highest priority condition among the first to fourth conditions and satisfies the greatest number of conditions.

In this way, the present disclosure proposes conditions of the gate electrode 118 to implement a field emission device with excellent field emission performance and reliability.

In other words, the conditions of the gate electrode 118 may include a first condition for the work function, a second condition for the Gibbs free energy of the redox reaction with the insulating layer 116, a third condition for the sublimation energy, and a fourth condition for the electron mean free path.

The reason why the work function of the gate electrode 118 is included among the conditions of the gate electrode 118 is as follows.

This is because, in the field emission device 110, if voltage is applied to the bottom electrode 114 and the top electrode 119, a strong electric field is induced in a thin area (tunnel barrier layer) of the insulating layer 116, and electron tunneling begins, and thus as the work function of the gate electrode 118 decreases, the electric field of the tunnel barrier layer increases, which increases the tunneling current, thereby increasing the field emission performance of the field emission device 110.

In addition, the reason why the Gibbs free energy of the redox reaction is included among the conditions of the gate electrode 118 is as follows.

This is because, the thermal, chemical, and electrical stability of the gate electrode 118 in contact with the insulating layer 116 (particularly, the tunnel barrier layer) is a factor related to the reliability of the field emission device 110, and it is important to select the material of the gate electrode 118 so that the phenomenon of the gate electrode 118 diffusing into the insulating layer 116 or reacting with the material of the insulating layer 116 does not occur.

In addition, the reason why sublimation energy is included among the conditions of the gate electrode 118 is as follows.

This is because, the gate electrode 118 diffusion occurs more easily as sublimation energy of the gate electrode material is lower, and the reaction occurs more easily as the Gibbs free energy for the redox reaction with the insulating layer 116 material is lower (the more negative the value).

In addition, the reason why the electron mean free path is included among the conditions of the gate electrode 118 is as follows.

This is because, in order for electrons that have passed through the tunnel barrier layer of the insulating layer 116 in the semiconductor substrate 112 and reached the gate electrode 118 to be emitted out of the field emission device 110 through the gate electrode 118 through the tunneling phenomenon, the electrons must minimize their energy loss at the gate electrode 118.

If electrons lose energy due to scattering at the gate electrode 118 and have energy lower than the work function of the gate electrode 118, they are not emitted out of the field emission device 110, and thus scattering of the electron at the gate electrode 118 must be minimized, and therefore, the mean free path of electrons in the gate electrode material must be long.

Meanwhile, the thickness of the gate electrode 118 may be from about 0.1 nm to about 100 nm.

Additionally, the gate electrode 118 can be formed in contact with the insulating layer 116.

For example, the insulating layer 116 may include at least one of SiO₂, SiNₓ, Al₂O₃, and Ti₂O₃, but this is only an example and is not limited thereto.

Additionally, the thickness of the insulating layer 116 may be about 5 nm to about 30 nm.

Here, the reason why the thickness of the gate electrode 118 and the insulating layer 116 is set to a predetermined range is that if the preset thickness range is exceeded, the field emission performance and reliability may deteriorate.

In addition, the semiconductor substrate 112 may include a plurality of electron beam emitting regions 112a and electron beam non-emitting regions 112b.

Next, the top electrode 119 can be placed on the gate electrode 118 located in the electron beam non-emitting region 112b.

Next, the semiconductor substrate 112 is composed of a first conductive type or second conductive type semiconductor, and the first conductive type or second conductive type semiconductor may have a doping concentration in the range of 1×10¹⁴ cm⁻³ to 1×10²¹ cm⁻³.

For example, the semiconductor substrate 112 may be composed of n-type or p-type silicon, and the dopant may include one of boron, phosphorous, and arsenic, but this is only an example and is not limited thereto.

Additionally, the semiconductor substrate 112 may include a first semiconductor layer having a first doping concentration and a second semiconductor layer formed on the first semiconductor layer and having a second doping concentration lower than the first doping concentration.

For example, the first doping concentration of the first semiconductor layer may be 1×10¹⁹ cm⁻³, and the second doping concentration of the second semiconductor layer may be 1×10¹⁶ cm⁻³, but this is only an example and is not limited thereto.

In addition, the thickness of the second semiconductor layer can be thinner than the thickness of the first semiconductor layer.

Here, the thickness of the semiconductor substrate 112 and the second semiconductor layer may be about 10 nm to about 10 μm.

As an example, the second semiconductor layer may be formed as a single layer having a lower surface in contact with the first semiconductor layer and an upper surface in contact with the insulating layer.

Here, the second semiconductor layer can be formed in both the electron beam emitting region 112a and the electron beam non-emitting region 112b of the semiconductor substrate 112.

In some cases, the second semiconductor layer may be partially formed only in the electron beam emitting region 112a of the semiconductor substrate 112.

Here, the second semiconductor layer is formed to correspond one-to-one to each electron beam emitting region 112a of the semiconductor substrate 112, and the area of one second semiconductor layer may be the area of the corresponding electron beam emitting region 112a or more.

At this time, the area of the second semiconductor layer can be determined so as not to overlap with the top electrode 119 located in the electron beam non-emitting region 112b.

As another embodiment, the second semiconductor layer may be formed of a plurality of doping layers having different doping concentrations, and the doping concentration of the first doping layer in contact with the first semiconductor layer among the doping layers may be higher than the doping concentration of the second doping layer in contact with the insulating layer.

Here, the second semiconductor layer can be formed in both the electron beam emitting region 112a and the electron beam non-emitting region 112b of the semiconductor substrate 112.

In some cases, the second semiconductor layer may be partially formed only in the electron beam emitting region 112a of the semiconductor substrate 112.

Here, the second semiconductor layer is formed to correspond one-to-one to each electron beam emitting region 112a of the semiconductor substrate 112, and the area of one second semiconductor layer may be greater than the area of the corresponding electron beam emitting region 112a.

At this time, the area of the second semiconductor layer can be determined so as not to overlap with the top electrode 119 located in the electron beam non-emitting region 112b.

As another embodiment, the second semiconductor layer may be formed of a plurality of doping layers having different doping concentrations, and the doping concentration of the doping layers in the plurality of doping layers may gradually increase as they are closer to the first semiconductor layer, and may gradually decrease as they are closer to the insulating layer.

Thus, the reason why the present disclosure forms a doping layer with a low doping concentration in a part or the entire region of the surface of a semiconductor substrate 112 is as follows.

The quality of the insulating layer of a field emission device is an important factor that determines the performance and stability of the field emission device.

The insulating layer 116 is composed of silicon dioxide (SiO₂) formed by oxidizing silicon which is a semiconductor material, at high temperature, and during the oxidation process, the silicon dopant acts as an impurity and can increase the trap density within the silicon dioxide thin film.

If using a silicon substrate with a high doping concentration to minimize the resistance of the field emission device, the higher the doping concentration, the lower the resistance, but the thin film quality of the silicon dioxide insulating layer inevitably deteriorates.

Therefore, the present disclosure can obtain a high-quality silicon dioxide thin film without significantly increasing the resistance of the field emission device by forming a doping layer with a low doping concentration on a part or the entire area of the surface of a semiconductor substrate 112, and can secure the performance and reliability of the field emission device.

Additionally, the top electrode 119 can be electrically connected to the bottom electrode 114 so that a positive voltage can be applied.

Next, the thickness of the insulating layer 116 positioned in the electron beam emitting region 112a of the semiconductor substrate 112 may be thinner than the thickness of the insulating layer 116 positioned in the electron beam non-emitting region 112b of the semiconductor substrate 112.

Here, the thickness of the insulating layer 116 can be about 5 nm to about 30 nm.

In addition, the insulating layer 116 may include at least one of SiO₂, SiNₓ, Al₂O₃, and Ti₂O₃, but this is only an example and is not limited thereto.

In this way, the present disclosure can improve field emission performance, reliability and stability by forming a semiconductor layer, an insulating layer and a gate electrode layer based on specific conditions.

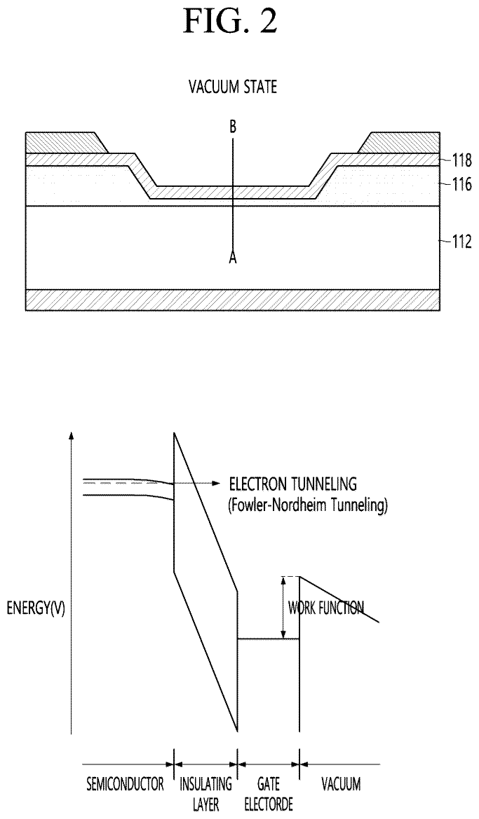

FIG. 2 is a view illustrating an energy band diagram of a field emission device according to an embodiment of the present disclosure.

As illustrated in FIG. 2, in the field emission device of the present disclosure, if a certain voltage is applied to the bottom electrode and the top electrode, a strong electric field is induced in a region where the thickness of the insulating layer 116 is thin, and due to this electric field, electrons can tunnel (Fowler-Nordheim) from the semiconductor layer of the semiconductor substrate 112 toward the gate electrode 118 and reach the gate electrode 118.

Among the electrons that reach the gate electrode 118, electrons that have energy higher than the work function of the gate electrode 118 can pass through the gate electrode 118 and be emitted into the external space, which is a vacuum state.

Here, the gate electrode 118 can be a major factor that determines the probability that electrons of the semiconductor will pass through the insulating layer and the gate electrode and be emitted into the vacuum space.

Accordingly, the present disclosure may configure the gate electrode 118 with a material satisfying at least one of a first condition for a work function, a second condition for a Gibbs free energy of a redox reaction with an insulating layer, a third condition for a heat of sublimation, and a fourth condition for an electron mean free path.

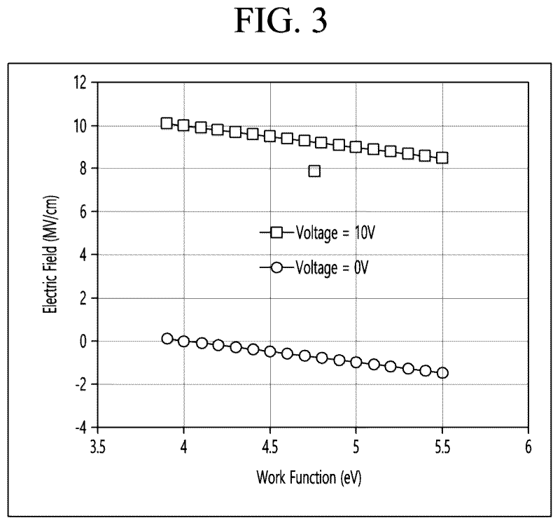

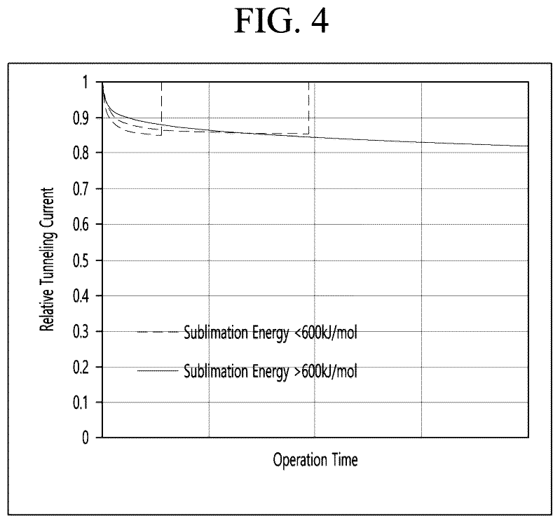

FIGS. 3 and 4 are graphs illustrating the performance of a field emission device according to the conditions of the gate electrode.

The present disclosure proposes the following conditions of a gate electrode in order to realize a field emission device having excellent field emission performance and reliability.

The conditions of the gate electrode may include a first condition for the work function, a second condition for the Gibbs free energy of the redox reaction with the insulating layer, a third condition for sublimation energy, and a fourth condition for the electron mean free path.

As illustrated in FIG. 3, when voltage is applied to the bottom electrode and the top electrode, a strong electric field is induced in a thin area of the insulating layer (tunnel barrier layer) in the field emission device, and electron tunneling begins, and thus as the work function of the gate electrode decreases, the electric field of the tunnel barrier layer increases, which increases the tunneling current, thereby increasing the field emission performance of the field emission device.

Accordingly, the present disclosure can configure the gate electrode with a material selected from among materials having a work function of about 5.5 eV or less.

In addition, as illustrated in FIG. 4, the thermal, chemical, and electrical stability of the gate electrode in contact with the insulating layer (particularly, the tunnel barrier layer) can be related to the reliability of the field emission device.

Therefore, it is important to select the material of the gate electrode so that the phenomenon of the gate electrode diffusing into the insulating layer or reacting with the insulating layer material does not occur.

The gate electrode can easily diffusion when sublimation energy of the gate electrode material is low, and the reaction can easily occur when the Gibbs free energy for redox reaction with the insulating layer material is low (the more negative the value).

Accordingly, the present disclosure can configure the gate electrode with a material selected from among materials having a Gibbs free energy of a positive value and a heat of sublimation of about 300 kJ/mol or more.

In addition, in order for electrons that have passed through the tunnel barrier layer of the insulating layer in the semiconductor substrate and reached the gate electrode to be emitted out of the field emission device through the gate electrode through the tunneling phenomenon, the electrons must minimize their energy loss at the gate electrode.

If electrons lose energy due to scattering at the gate electrode and have energy lower than the work function of the gate electrode, they will not be emitted out of the field emission device, and thus, scattering at the gate electrode must be minimized, and the mean free path of electrons in the gate electrode material must be long.

Accordingly, the present disclosure can configure the gate electrode with a material selected from materials having an electron mean free path of about 0.9 nm or more.

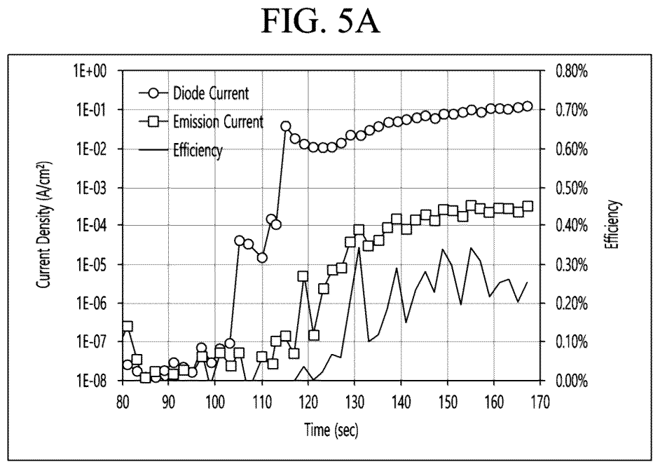

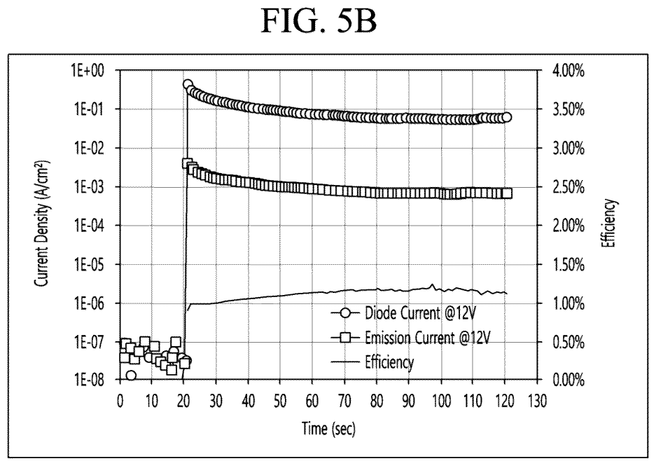

FIGS. 5a and 5b are graphs illustrating the performance of a field emission device according to the material of the gate electrode.

FIG. 5a is a graph illustrating the performance of a field emission device using a Ni/Au metal compound having a work function of about 5.3 as a gate electrode material, and FIG. 5b is a graph illustrating the performance of a field emission device using graphene having a work function of about 4.5 as a gate electrode material.

As illustrated in FIGS. 5a and 5b, performance indicators of a field emission device may include emission efficiency, which is calculated as the ratio of an emission current through which electrons are emitted and a diode current, which represents the electrical performance of a diode.

Therefore, the present disclosure was able to increase the emission current density and emission efficiency by applying Ni/Au and graphene materials with low work functions as gate electrode materials.

In other words, the present disclosure can improve the emission current density and emission efficiency by applying a material having a work function of about 5.5 eV or less as a gate electrode material among the conditions of the gate electrode.

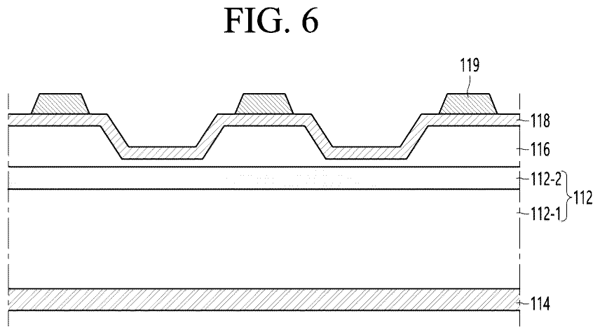

FIG. 6 is a cross-sectional view illustrating a field emission device according to another embodiment of the present disclosure.

As illustrated in FIG. 6, the field emission device of the present disclosure may include a semiconductor substrate 112, a bottom electrode 114 disposed below the semiconductor substrate 112, an insulating layer 116 disposed above the semiconductor substrate 112, a gate electrode 118 disposed on the insulating layer 116, and a top electrode 119 disposed on the gate electrode 118.

Here, the semiconductor substrate 112 may include a first semiconductor layer 112-1 having a first doping concentration and a second semiconductor layer 112-2 formed on the first semiconductor layer 112-1 and having a second doping concentration lower than the first doping concentration.

For example, the first doping concentration of the first semiconductor layer 112-1 may be 1×10¹⁹ cm⁻³, and the second doping concentration of the second semiconductor layer 112-2 may be 1×10¹⁶ cm⁻³, but this is only an example and is not limited thereto.

In addition, the thickness of the second semiconductor layer 112-2 can be thinner than the thickness of the first semiconductor layer 112-1.

Here, the thickness of the second semiconductor layer 112-2 can be about 10 nm to about 10 um.

In this way, the second semiconductor layer 112-2 can be formed as a single layer with the lower surface contacting the first semiconductor layer 112-1 and the upper surface contacting the insulating layer 116.

Here, the second semiconductor layer 112-2 can be formed in both the electron beam emitting region 112a and the electron beam non-emitting region 112b of the semiconductor substrate 112.

Thus, the reason why the present disclosure forms a doping layer with a low doping concentration in a part or the entire region of the surface of a semiconductor substrate 112 is as follows.

The quality of the insulating layer of a field emission device is an important factor that determines the performance and stability of the field emission device.

The insulating layer 116 is composed of silicon dioxide (SiO₂) formed by oxidizing silicon which is a semiconductor material, at high temperature, and thus during the oxidation process, the silicon dopant acts as an impurity and can increase the trap density within the silicon dioxide thin film.

If using a silicon substrate with a high doping concentration to minimize the resistance of the field emission device, the higher the doping concentration, the lower the resistance, but the thin film quality of the silicon dioxide insulating layer inevitably deteriorates.

Therefore, the present disclosure can obtain a high-quality silicon dioxide thin film without significantly increasing the resistance of the field emission device by forming a doping layer with a low doping concentration on a part or the entire area of the surface of a semiconductor substrate 112, and can secure the performance and reliability of the field emission device.

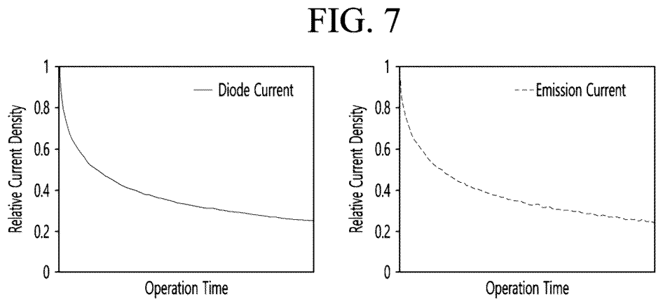

FIG. 7 is a graph illustrating electrical characteristics of a field emission device according to another embodiment of the present disclosure.

The semiconductor substrate of the present disclosure may be configured with a first semiconductor layer in contact with a bottom electrode as a layer having a relatively high doping concentration, and a part or the entire area of a second semiconductor layer in contact with an insulating film as a surface on which an oxidation process is performed may be configured with a layer having a relatively low doping concentration.

Through this, the present disclosure can reduce changes in diode current and emission current over time while minimizing performance degradation of the field emission device due to resistance of the semiconductor substrate, as illustrated in FIG. 7, thereby ensuring current stability and reliability of the field emission device.

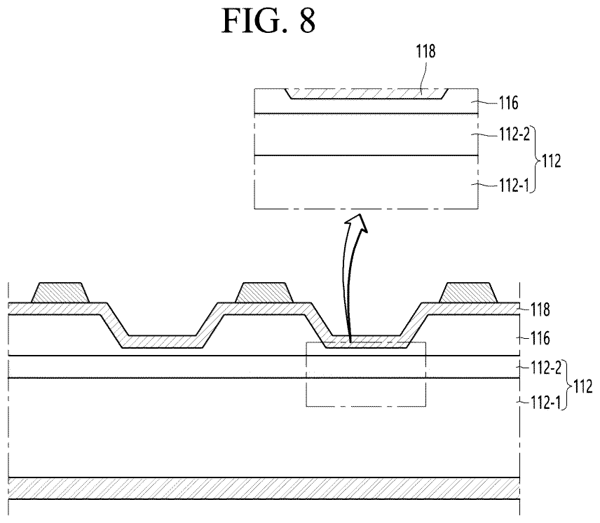

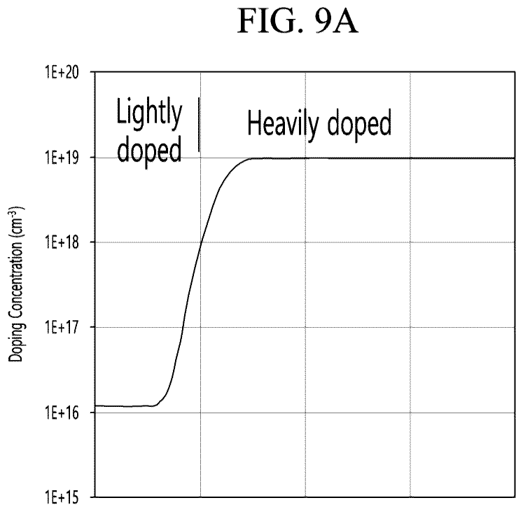

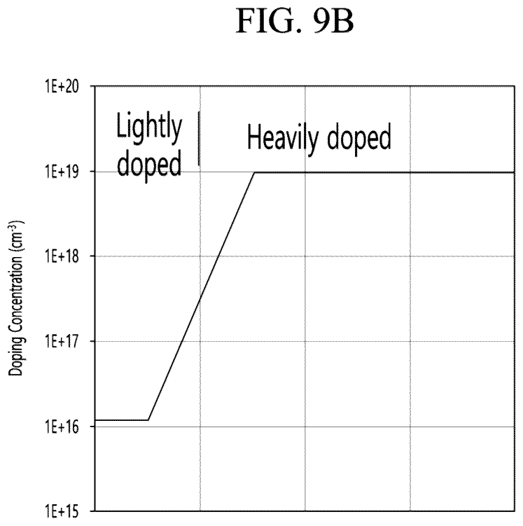

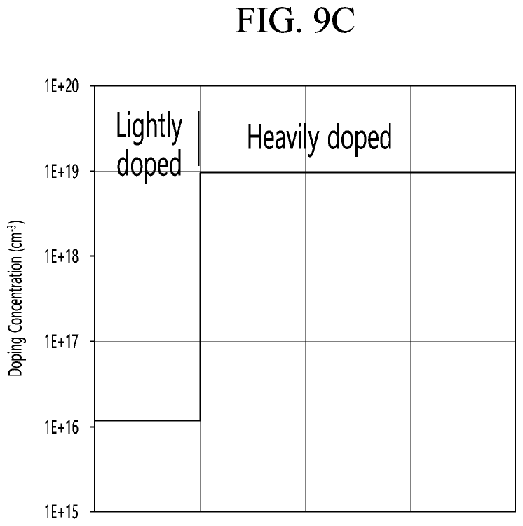

FIG. 8 is a cross-sectional view illustrating the boundary between semiconductor layers with different doping concentrations, and FIGS. 9a to 9c are graphs illustrating the doping profile of the AB cross section of FIG. 8.

As illustrated in FIG. 8, the semiconductor substrate 112 of the present disclosure may include a first semiconductor layer 112-1 having a first doping concentration, and a second semiconductor layer 112-2 formed on the first semiconductor layer 112-1 and having a second doping concentration lower than the first doping concentration.

As illustrated in FIGS. 9a to 9c, the doping profile of the interface (A-B cross-section) between the heavily doped first semiconductor layer 112-1 and the lightly doped second semiconductor layer 112-2 may be in a graded or abrupt shape.

FIGS. 9a to 9c are graphs illustrating the doping profile of the interface between the first semiconductor layer 112-1 and the second semiconductor layer 112-2 when the first doping concentration of the first semiconductor layer 112-1 is about 1×10¹⁹ cm⁻³ and the second doping concentration of the second semiconductor layer 112-2 is about 1×10¹⁶ cm⁻³.

As illustrated in FIG. 9a, the doping profile of the interface between the first semiconductor layer 112-1 and the second semiconductor layer 112-2 may have a Gaussian doping profile in a graded shape.

In some cases, as illustrated in FIG. 9b, the doping profile of the boundary between the first semiconductor layer 112-1 and the second semiconductor layer 112-2 may have a linear-graded doping profile in a graded shape.

In another case, as illustrated in FIG. 9C, the doping profile of the interface between the first semiconductor layer 112-1 and the second semiconductor layer 112-2 may have an abrupt-shaped doping profile.

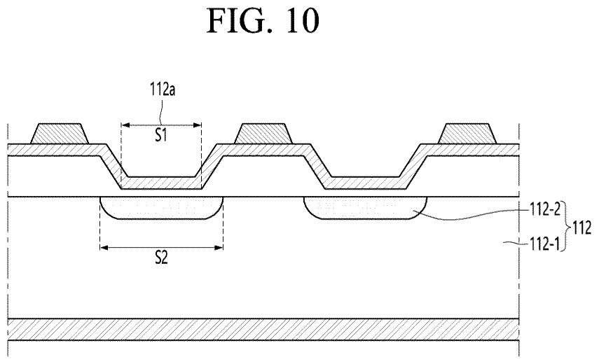

FIGS. 10 to 12 are cross-sectional views illustrating a field emission device according to another embodiment of the present disclosure.

As illustrated in FIG. 10, the semiconductor substrate 112 of the present disclosure may include a first semiconductor layer 112-1 having a first doping concentration, and a second semiconductor layer 112-2 formed on the first semiconductor layer 112-1 and having a second doping concentration lower than the first doping concentration.

Here, the second semiconductor layer 112-2 may be partially formed only in the electron beam emission region 112a of the semiconductor substrate 112.

Here, the second semiconductor layer 112-2 is formed to correspond one-to-one to each electron beam emitting region 112a of the semiconductor substrate 112, and the area S2 of one second semiconductor layer 112-2 may be greater than or equal to the area S1 of the corresponding electron beam emitting region 112a.

At this time, the area S2 of the second semiconductor layer 112-2 can be determined so as not to overlap with the top electrode 119 located in the electron beam non-emitting region 112b.

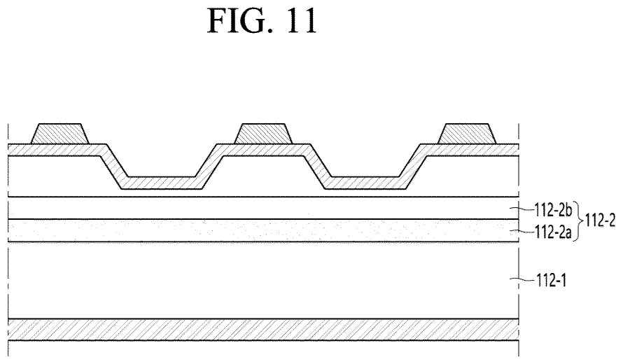

As another embodiment, as illustrated in FIG. 11, the second semiconductor layer 112-2 may be formed of a plurality of doping layers 112-2a, 112-2b having different doping concentrations.

Here, the doping concentration of the first doping layer 112-2a in contact with the first semiconductor layer 112-1 among the doping layers may be higher than the doping concentration of the second doping layer 112-2b in contact with the insulating layer 116.

Here, the second semiconductor layer 112-2 can be formed in both the electron beam emitting region 112a and the electron beam non-emitting region 112b of the semiconductor substrate 112.

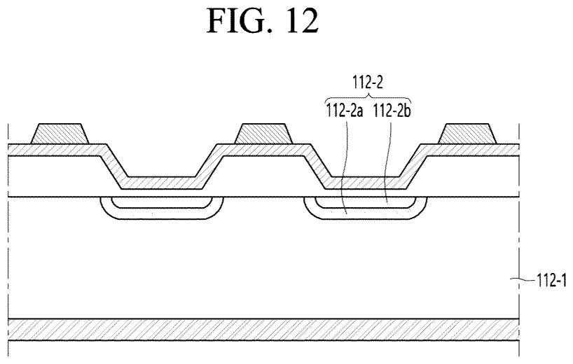

In some cases, as illustrated in FIG. 12, the second semiconductor layer 112-2 may be partially formed only in the electron beam emitting region 112a of the semiconductor substrate 112.

Here, the second semiconductor layer 112-2 is formed to correspond one-to-one to each electron beam emitting region 112a of the semiconductor substrate 112, and the area of one second semiconductor layer 112-2 may be greater than or equal to the area of the corresponding electron beam emitting region 112a.

At this time, the area of the second semiconductor layer 112-2 can be determined so as not to overlap with the top electrode 119 located in the electron beam non-emitting region 112b.

In another case, the second semiconductor layer 112-2 is composed of a plurality of doping layers having different doping concentrations, and the doping concentration of the doping layer of the plurality of doping layers may gradually increase as it approaches the first semiconductor layer, and may gradually decrease as it approaches the insulating layer.

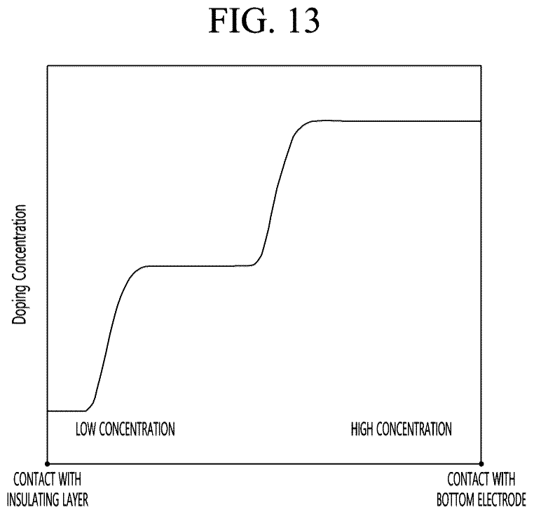

FIG. 13 is a graph illustrating the doping profile for the field emission devices of FIGS. 11 and 12.

As illustrated in FIG. 13, if the second semiconductor layer is formed of a plurality of doping layers having different doping concentrations, the doping profile at the boundary between the doping layers may have an abrupt-shaped doping profile.

In this way, the present disclosure can obtain a high-quality insulating thin film without significantly increasing the resistance of the field emission device by forming a doping layer with a low doping concentration on a part or the entire area of the surface of a semiconductor substrate, and can secure the performance and reliability of the field emission device.

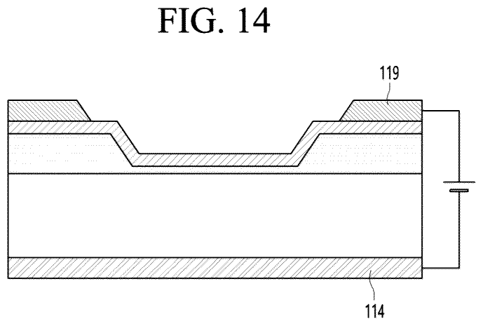

FIG. 14 is a cross-sectional view illustrating electrical connections of a field emission device according to one embodiment of the present disclosure.

As illustrated in FIG. 14, the top electrode 119 of the present disclosure can be electrically connected to the bottom electrode 114 so that a positive voltage can be applied.

In other words, in the present disclosure, after a positive voltage is applied to the top electrode 119 and a negative voltage is applied to the bottom electrode 114, if the threshold voltage is exceeded, electron tunneling may occur in the tunnel barrier layer of the field emission device and field emission may begin.

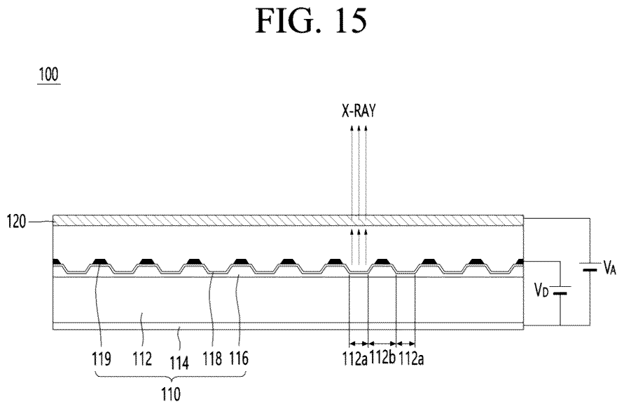

FIGS. 15 to 17 are cross-sectional views illustrating an X-ray generating apparatus according to an embodiment of the present disclosure.

As illustrated in FIG. 15, the X-ray generating apparatus of the present disclosure may include a field emission device 110 in which a plurality of electron beam emitting regions 112a are arranged, and an anode 120 that generates X-rays by collision with electrons emitted from the electron beam emitting regions 112a of the field emission device 110 and reflects and transmits them in a specific direction.

Here, the field emission device 110 may include a semiconductor substrate 112, a bottom electrode 114 disposed below the semiconductor substrate 112, an insulating layer 116 disposed above the semiconductor substrate 112, a gate electrode 118 disposed on the insulating layer 116, and a top electrode 119 disposed on the gate electrode 118.

Here, the gate electrode 118 may be composed of a material that satisfies at least one of the first condition for the work function, the second condition for the Gibbs free energy of the redox reaction with the insulating layer 116, the third condition for the sublimation energy, and the fourth condition for the electron mean free path.

For example, the gate electrode 118 may be composed of a material that satisfies one of a first condition in which the work function is about 5.5 eV or less, a second condition in which the Gibbs free energy has a positive value, a third condition in which sublimation energy is about 300 kJ/mol or more, and a fourth condition in which the electron mean free path is about 0.9 nm or more.

As another example, the gate electrode 118 may be composed of a material that satisfies a plurality of conditions among a first condition in which the work function is about 5.5 eV or less, a second condition in which the Gibbs free energy has a positive value, a third condition in which sublimation energy is about 300 kJ/mol or more, and a fourth condition in which the electron mean free path is about 0.9 nm or more.

As another example, the gate electrode 118 may be composed of any one of graphene, metal, and metal compound materials that satisfy multiple conditions among a first condition in which the work function is about 5.5 eV or less, a second condition in which the Gibbs free energy has a positive value, a third condition in which sublimation energy is about 300 kJ/mol or more, and a fourth condition in which the electron mean free path is about 0.9 nm or more.

Additionally, the semiconductor substrate 112 may include a first semiconductor layer having a first doping concentration and a second semiconductor layer formed on the first semiconductor layer and having a second doping concentration lower than the first doping concentration.

In addition, the anode 120 is disposed at a predetermined interval so as to have a predetermined space from the field emission device 110, and the predetermined space between the anode 120 and the field emission device 110 can be in a vacuum state.

Here, the anode 120 can be disposed to cover the entire area of the field emission device 110.

Additionally, the bottom electrode 114 can be electrically connected in parallel to the top electrode 119 and the anode 120.

Here, the top electrode 119 can be applied with a first positive voltage, and the anode 120 can be applied with a second positive voltage.

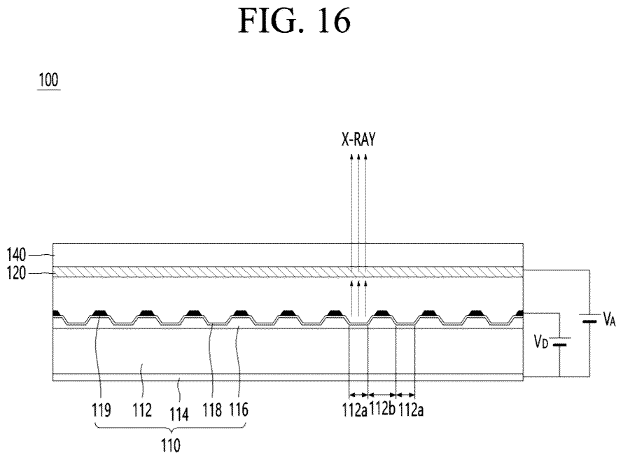

As another embodiment, as illustrated in FIG. 16, the present disclosure may further include a transmission window 140 disposed over the anode 120 and transmitting X-rays.

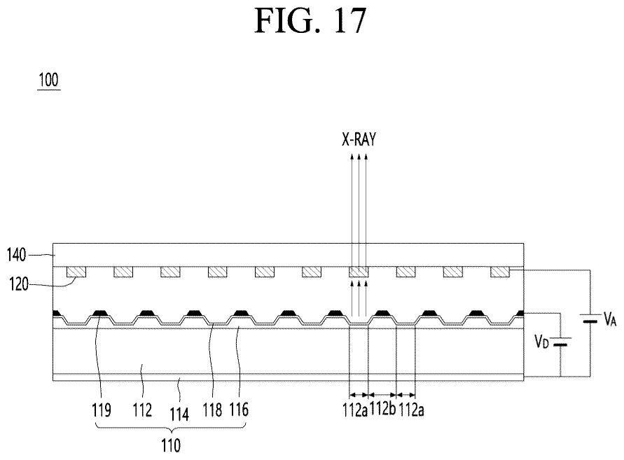

As another embodiment, as illustrated in FIG. 17, the present disclosure may also dispose the anode 120 to cover only a part of the area of the field emission device 110.

In other words, the anode 120 can be disposed to cover only the electron beam emission regions 112a of the field emission device 110.

Here, the anode 120 is arranged so that a plurality of sub-anodes are separated and spaced apart at a certain interval, and the sub-anodes can be arranged corresponding to the electron beam emission region 112a of the field emission device 110.

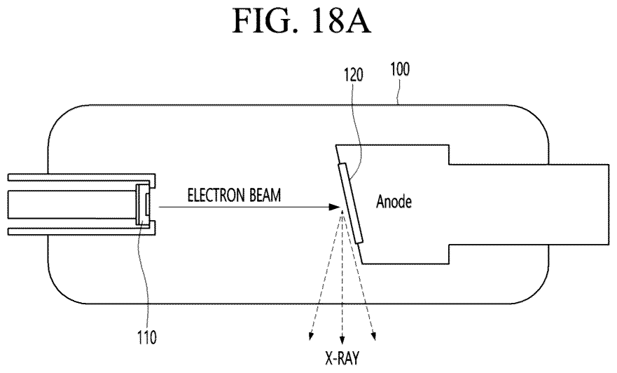

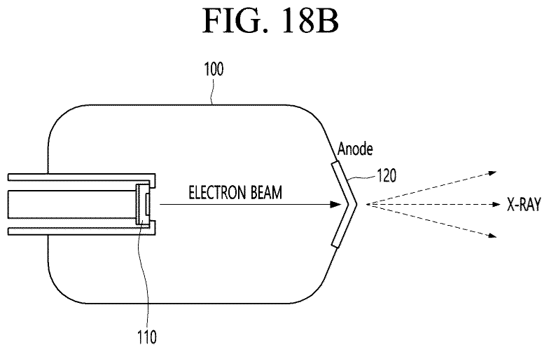

FIGS. 18a and 18b are views illustrating an X-ray tube to which the field emission device of the present disclosure is applied.

As illustrated in FIGS. 18a and 18b, the present disclosure can be applied to an X-ray tube.

As illustrated in FIG. 18a, the reflective X-ray tube of the X-ray generating apparatus 100 is spaced apart at a predetermined interval so that the reflective anode 120 has a predetermined space from the field emission device 110, and the predetermined space between the anode 120 and the field emission device 110 can be in a vacuum state.

In addition, when an electron beam is emitted from the electron beam emission region of the field emission device 110, the reflective anode 120 can generate an X-ray by collision with the electrons and reflect it in a specific direction.

In addition, as illustrated in FIG. 18b, the transmission type X-ray tube of the X-ray generating apparatus 100 is arranged at a predetermined interval so that the reflection type anode 120 has a predetermined space from the field emission device 110, and the predetermined space between the anode 120 and the field emission device 110 can be in a vacuum state.

In addition, when an electron beam is emitted from the electron beam emission region of the field emission device 110, the transmission type anode 120 can generate X-rays by collision with electrons and transmit them in a specific direction.

In this way, the field emission device of the present disclosure and the X-ray generating apparatus using the same can improve field emission performance, reliability, and stability by forming a semiconductor layer, an insulating layer, and a gate electrode layer based on specific conditions.

### INDUSTRIAL APPLICABILITY

According to the field emission device according to the present disclosure, the field emission performance, reliability and stability can be improved by forming a semiconductor layer, an insulating layer and a gate electrode layer based on specific conditions, and therefore, the industrial applicability is remarkable.

1. A field emission device comprising:
a semiconductor substrate;
a bottom electrode disposed below the semiconductor substrate;
an insulating layer disposed above the semiconductor substrate;
a gate electrode disposed on the insulating layer; and,
a top electrode disposed on the gate electrode;
wherein the gate electrode is composed of a material satisfying at least one of a first condition for work function, a second condition for Gibbs free energy of a redox reaction with the insulating layer, a third condition for sublimation energy, and a fourth condition for electron mean free path.

2. The field emission device of claim 1,
wherein the gate electrode is composed of a material satisfying one of a first condition in which the work function is 5.5 eV or less, a second condition in which the Gibbs free energy has a positive value, a third condition in which the sublimation energy is 300 kJ/mol or more, and a fourth condition in which the electron mean free path is 0.9 nm or more.

3. The field emission device of claim 1,
wherein the gate electrode is composed of a material that satisfies a plurality of conditions among a first condition in which the work function is 5.5 eV or less, a second condition in which the Gibbs free energy has a positive value, a third condition in which the sublimation energy is 300 kJ/mol or more, and a fourth condition in which the electron mean free path is 0.9 nm or more.

4. The field emission device of claim 1,
wherein the gate electrode is composed of a material that satisfies a condition with a higher priority among the first to fourth conditions based on a preset priority.

5. The field emission device of claim 1,
wherein the thickness of the gate electrode is 0.1 nm to 100 nm.

6. The field emission device of claim 1,
wherein the gate electrode is formed by being in contact with the insulating layer.

7. The field emission device of claim 6,
wherein the thickness of the insulation layer is 5 nm to 30 nm.

8. The field emission device of claim 1,
wherein the semiconductor substrate includes,
a first semiconductor layer having a first doping concentration; and,
a second semiconductor layer formed on the first semiconductor layer and having a second doping concentration lower than the first doping concentration.

9. The field emission device of claim 8,
wherein the second semiconductor layer has a lower surface beng in contact with the first semiconductor layer and a upper surface formed of a single layer in contact with the insulating layer.

10. The field emission device of claim 9,
wherein the second semiconductor layer is partially formed only in the electron beam emitting region of the semiconductor substrate.

11. The field emission device of claim 8,
wherein the second semiconductor layer is composed of a plurality of doping layers with different doping concentrations, and
wherein the doping concentration of the first doping layer in contact with the first semiconductor layer among the doping layers is higher than the doping concentration of the second doping layer in contact with the insulating layer.

12. The field emission device of claim 11,
wherein the second semiconductor layer is partially formed only in the electron beam emitting region of the semiconductor substrate.

13. The field emission device of claim 8,
wherein the second semiconductor layer is composed of a plurality of doping layers with different doping concentrations,
wherein the plurality of doping layers are configured so that the doping concentration of the doping layer gradually increases as approaching the first semiconductor layer, and the doping concentration of the doping layer gradually decreases as approaching the insulating layer.

14. An X-ray generating apparatus comprising:
a field emission device having a plurality of electron beam emitting regions arranged; and
an anode generating X-rays by collision with electrons emitted from the electron beam emission region of the field emission device and reflects and transmits the X-rays in a specific direction,
wherein the field emission device includes:
a semiconductor substrate;
a bottom electrode disposed below the semiconductor substrate;
an insulating layer disposed above the semiconductor substrate;
a gate electrode disposed on the insulating layer; and,
a top electrode disposed on the gate electrode;
wherein the gate electrode is composed of a material satisfying at least one of a first condition for work function, a second condition for Gibbs free energy of a redox reaction with the insulating layer, a third condition for sublimation energy, and a fourth condition for electron mean free path.

15. The X-ray generating apparatus of claim 14, further comprising:
a transmission window disposed above the anode and transmitting the X-rays.
